(19) United States
(12) Patent Application Publication
(10) Pub. No.: US 2026/0119090 A1
(43) Pub. Date: Apr. 30, 2026

(54) NON-TRANSITORY COMPUTER-READABLE STORAGE MEDIUM STORING PROGRAM, INFORMATION PROCESSING APPARATUS, AND SETTING METHOD

(71) Applicant: SEIKO EPSON CORPORATION, Tokyo (JP)

(72) Inventor: Yusuke MASE, Shiojiri (JP)

(21) Appl. No.: 19/366,592

(22) Filed: Oct. 23, 2025

(30) Foreign Application Priority Data
Oct. 25, 2024 (JP) 2024-188055

(51) Int. Cl. G06F 3/12

(52) U.S. Cl. CPC G06F 3/1225; G06F 3/1203; G06F 3/1228

(57) ABSTRACT

A program for extending a general-purpose driver causes a computer to execute acquiring processing of acquiring, from a printing apparatus, main body information of the printing apparatus, and first generation processing of generating, based on the main body information, a setting file including data to be used for setting one or more linked applications.

The present application is based on, and claims priority from JP Application Serial Number 2024-188055, filed October 25, 2024, the disclosure of which is hereby incorporated by reference herein in its entirety.

### BACKGROUND

### 1. Technical Field

The present disclosure relates to a non-transitory computer-readable storage medium storing a program, an information processing apparatus, and a setting method.

### 2. Related Art

In printing, a computer may control a printer by using a general-purpose driver incorporated in an operating system (OS) instead of using a dedicated printer driver.

For example, JP-A-2023-141759 discloses a support program for supporting a general-purpose print program. When an OS receives an activation instruction in a state where a printer is selected, the support program causes a CPU of a personal computer (PC) to acquire capability information of the printer via the general-purpose print program. Furthermore, the support program causes the CPU to display a list of information indicating applications that use capability indicated by the capability information from among a plurality of applications to be managed. This enables the PC to receive an instruction to execute the displayed application.

An object of the support program of JP-A-2023-141759 is to improve an interface for displaying applications to be managed. However, it is also desired that an application related to printing be able to be used more efficiently.

### SUMMARY

A non-transitory computer-readable storage medium according to an aspect of the present disclosure stores a program for extending a general-purpose driver, the program causing a computer to execute acquiring processing of acquiring, from a printing apparatus, main body information of the printing apparatus, and first generation processing of generating, based on the main body information, a setting file including data to be used for setting one or more linked applications.

An information processing apparatus according to an aspect of the present disclosure includes an acquisition section that acquires, from a printing apparatus, main body information of the printing apparatus, and a generation section that generates, based on the main body information, a setting file including data to be used for setting one or more linked applications.

A setting method according to an aspect of the present disclosure includes, by a computer, acquiring, from a printing apparatus, main body information of the printing apparatus; and generating, based on the main body information, a setting file including data to be used for setting one or more linked applications.

### BRIEF DESCRIPTION OF THE DRAWINGS

FIG. 1 is a block diagram illustrating an example of a print system according to a first embodiment.

FIG. 2 is a block diagram illustrating an example of an external computer according to the first embodiment.

FIG. 3 is a diagram illustrating an example of a printer according to the first embodiment.

FIG. 4 is a sequence diagram illustrating a flow of setting in the print system according to the first embodiment.

FIG. 5 is a flowchart illustrating a procedure of linked application activation processing according to the first embodiment.

FIG. 6 is a block diagram illustrating an example of an external computer according to a second embodiment.

FIG. 7 is a diagram illustrating a display screen for selecting a linked application according to the second embodiment.

FIG. 8 is a diagram illustrating a display screen for collective registration of a printer according to the second embodiment.

### DESCRIPTION OF EMBODIMENTS

Hereinafter, embodiments of the disclosure will be described with reference to the drawings. For the sake of clarification of description, in the following description and drawings, omission and simplification are appropriately performed. Each drawing to be referred to is merely an example for describing one or more embodiments. Not all of features or processes illustrated in any one of the drawings for describing an exemplary embodiment are essential, and some of the features or processes may be omitted. In each drawing, the same elements are denoted by the same reference numerals, and repeated description thereof will be omitted as necessary.

### First Embodiment

### Description of Configuration

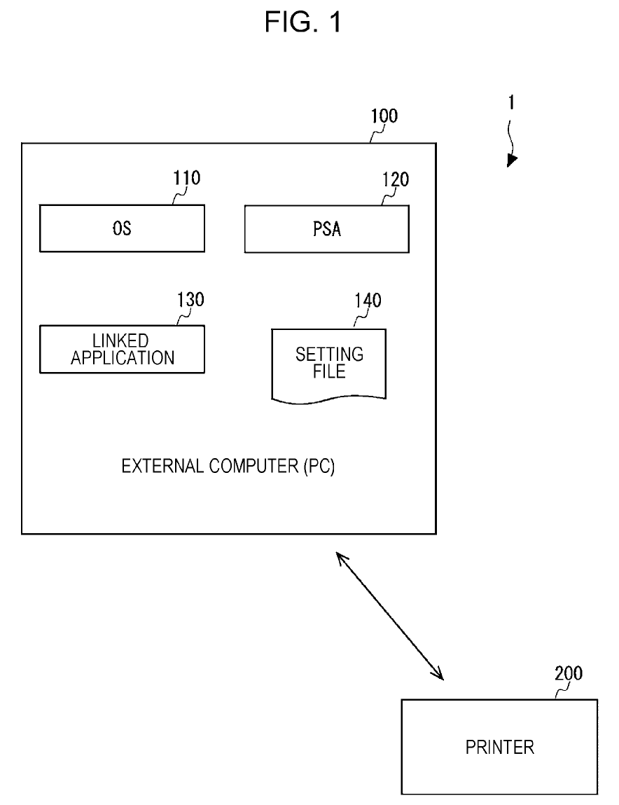

FIG. 1 is a block diagram illustrating an example of a print system according to the present disclosure. A print system 1 includes an external computer 100 and a printer 200. The external computer 100 is communicably connected to the printer 200 in a wired or wireless manner. For example, the external computer 100 may be communicably connected to the printer 200 via a local area network (LAN) such as a wireless LAN. Furthermore, the external computer 100 may be communicably connected to the printer 200 via the Internet, for example.

The external computer 100 is a computer including a processor and a memory. The external computer 100 is, for example, an information processing apparatus or an information processing terminal such as a personal computer (PC). The external computer 100 functions as an information processing apparatus that sets a print mode of the printer 200 and provides an instruction to perform printing to the printer 200. The printer 200 is any printing apparatus having a printing function. For the printer 200, it is possible to use any printing method such as an ink jet method or an electrophotographic method. The printer 200 executes printing in accordance with the instruction from the external computer 100.

The external computer 100 includes an operating system (OS) 110, a print support application (PSA) 120, a linked application 130, and a setting file 140.

The OS 110 is basic software that controls operations of the external computer 100. Although the OS 110 may be, for example, Windows (registered trademark), the OS 110 is not limited thereto. In the following description, an example in which the OS 110 is Windows will be described as appropriate.

At the time of print processing, the OS 110 generates print data and outputs it to the PSA 120. Furthermore, the OS 110 acquires main body information of the printer 200 from the printer 200 before the print processing and outputs the acquired main body information to the PSA 120. The main body information of the printer 200 is any information related to the printer 200. The main body information may include, for example, any parameters for setting a print mode of the printer 200. The main body information may be set in the printer 200 in advance or may be set by a user.

The PSA 120 is a general-purpose printer driver and is an OS 110 standard printer driver in this example. The PSA 120 is software for controlling the printer 200 and causing the printer 200 to operate. Upon acquiring the print data from the OS 110, the PSA 120 generates a print job including the print data. The print job is a command for causing the printer 200 to print an image indicated by the print data.

Furthermore, the PSA 120 includes a program for executing the following functions and extending the driver. In response to an instruction from the user, the PSA 120 requests the main body information of the printer 200 via the OS 110. Once the main body information is acquired from the printer 200 in response to the request, the PSA 120 generates a setting file 140 including data to be used for setting the linked application 130 based on the main body information. The PSA 120 activates the linked application 130 in response to an instruction from the user.

The linked application 130 is any application software capable of performing processing involving printing by the printer 200. The linked application 130 may be, for example, document editing software, spreadsheet software, image editing software, or photograph display software. Although only one linked application 130 is illustrated in FIG. 1, the external computer 100 may include a plurality of linked applications 130.

In a case in which the setting file 140 for the linked application 130 has already been created when the linked application 130 is activated under control of the PSA 120, the linked application 130 can read the setting file 140. Accordingly, the linked application 130 can acquire setting information in the setting file 140 and execute setting processing in accordance with the main body information of the printer 200.

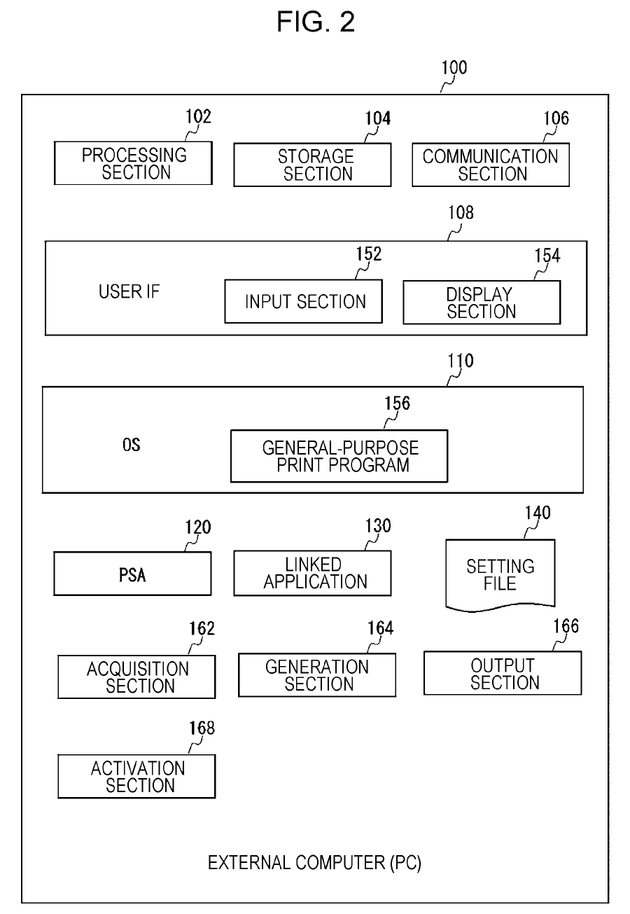

FIG. 2 is a block diagram illustrating an example of the external computer 100 according to the first embodiment. The external computer 100 includes a processing section 102, a storage section 104, a communication section 106, and a user interface (IF) 108 as main hardware configurations. The user IF 108 includes an input section 152 and a display section 154. The processing section 102, the storage section 104, the communication section 106, and the user IF 108 may be connected to each other via a data bus or the like.

The processing section 102 is a processor such as a central processing unit (CPU), a micro processing unit (MPU), or an application specific integrated circuit (ASIC), for example. The processing section 102 includes one or more processors. The processing section 102 has a function as a calculation device that performs control processing, calculation processing, and the like. The processing section 102 controls the storage section 104, the communication section 106, and the user IF 108.

The storage section 104 is a storage device including one or more memories or storages, or a combination thereof. The memories are configured by volatile memories, non-volatile memories, or a combination thereof. The volatile memories may be, for example, random access memories (RAMs). The non-volatile memories may be, for example, read only memories (ROMs). The storages may be flash memories, hard disk drives (HDDs), or solid state drives (SSDs). The storage section 104 has a function of storing a control program, a calculation program, and the like to be executed by the processing section 102. In addition, the storage section 104 has a function of temporarily storing processing data and the like. The storage section 104 can include a DB 140, which will be described below. The storage section 104 may store print setting information.

The communication section 106 performs processing necessary for the external computer 100 to communicate with another device via a communication network. The communication section 106 can include a communication port, a router, a firewall, and the like. For example, the communication section 106 performs processing for the external computer 100 to communicate with the printer 200. The communication section 106 may perform processing for the external computer 100 to communicate with the printer 200 via a LAN such as a wireless LAN. In addition, the communication section 106 may perform processing for the external computer 100 to communicate with the printer 200 via, for example, the Internet.

The user IF 108 includes the input section 152 which is an input device such as a button, a keyboard, or a mouse. The user inputs information to the external computer 100 by operating the input section 152. For example, the user can input an instruction for print setting and an instruction to execute printing to the external computer 100 by operating the input section 152.

The user IF 108 has the display section 154 which is a data output device. The display section 154 includes, for example, a display. The display section 154 displays a screen for setting a print mode under control of the linked application 130.

Note that the input section 152 and the display section 154 may be configured as a physically integrated device, such as a touch screen or a touch panel, for example.

In addition, the external computer 100 includes, as components, the OS 110, the PSA 120, the linked application 130, and the setting file 140 described above. The OS 110 includes a general-purpose print program 156 as a program. The general-purpose print program 156 is an OS standard program that does not depend on the linked application 130. The general-purpose print program 156 executes print data generation processing and main body information acquisition and output processing in the OS 110 described above. In a case in which the OS 110 is Windows, the general-purpose print program 156 may be, for example, an Internet Printing Protocol (IPP) Class Driver. The linked application 130 can acquire the main body information from the printer 200 connected to the external computer 100 by using the IPP Class Driver.

In addition, the external computer 100 further includes an acquisition section 162, a generation section 164, an output section 166, and an activation section 168 as components. The acquisition section 162, the generation section 164, the output section 166, and the activation section 168 may be implemented by the PSA 120 as functions for print setting. For example, the processing section 102 can implement each of the components by reading and executing a program related to the PSA 120 stored in the storage section 104. In addition, a necessary program may be recorded on any non-volatile recording medium and installed in the external computer 100 as necessary, and accordingly, each of the components may be implemented.

In addition, each component may be implemented not only by software using a program but also by a combination of, for example. any of hardware, firmware, and software. In addition, each component may be implemented by using an integrated circuit, which is programmable by the user, such as a field-programmable gate array (FPGA) or a microcomputer, for example. In this case, a program configured by each of the above-described components may be implemented by using this integrated circuit.

In a case in which there has been an instruction from the user via the input section 152, the acquisition section 162 acquires the main body information of the printer 200 via the general-purpose print program 156 in response to the instruction.

The generation section 164 generates the setting file 140 including data to be used for setting the linked application 130 based on the main body information acquired by the acquisition section 162. The generation section 164 can create the setting file 140 by converting the format of the main body information to match the setting format of the linked application 130 and using the converted main body information.

At this time, the generation section 164 can provide, in the setting file 140, a specification area for specifying initial setting at the time of the next activation of the linked application 130. The generation section 164 sets information corresponding to the acquired main body information in the specification area. For example, the main body information used when the linked application 130 used the printer 200 last time may be set in the specification area.

The output section 166 outputs the generated setting file 140 to an area for setting the linked application 130 that is a target of print setting. The area for setting the linked application 130 is, for example, a folder in which the linked application 130 is stored in the external computer 100. However, the area for setting may be an area other than the folder in which the linked application 130 is stored. Alternatively, the area for setting may be an area in a device connected to the external computer 100.

Note that in a case in which a setting file for the linked application 130 is originally not present in the area for setting, the generation section 164 can newly generate the setting file 140. The output section 166 outputs the generated setting file 140 to the area for setting. As a result, the setting file 140 is stored in the area for setting.

However, in another example, the generation section 164 can generate the setting file 140 for updating even in a case in which a setting file for the linked application 130 is originally present in the area for setting. The output section 166 updates the setting file that is present in the area for setting by outputting the generated setting file 140 to the area for setting. The setting file 140 is stored in the area for setting in this manner as well.

The output section 166 may cause the storage section 104 to store information indicating the location of the area for setting in which the setting file 140 is stored. The information indicating the location of the area for setting may be, for example, a path of the setting file 140.

In a case in which there has been an instruction from the user via the input section 152, the activation section 168 activates the linked application 130 in response to the instruction. Note that the activation section 168 may activate the linked application 130 after the output section 166 outputs the setting file 140. At this time, the user may include information for specifying the setting file 140 in the instruction. The information for specifying the setting file 140 may be input by a command line. The information for specifying the setting file 140 may be information for specifying the setting file 140 itself, such as a name of the setting file 140, or may be the path of the setting file 140.

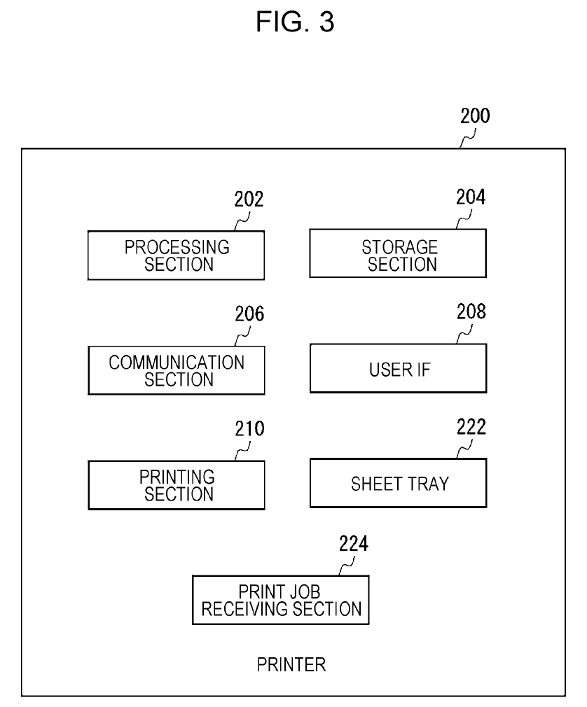

FIG. 3 is a block diagram illustrating an example of the printer 200 according to the first embodiment. The printer 200 includes, as main hardware configurations, a processing section 202, a storage section 204, a communication section 206, a user IF 208, a printing section 210, a sheet tray 222, and a print job receiving section 224. The processing section 202, the storage section 204, the communication section 206, the user IF 208, and the printing section 210 may be connected to each other via a data bus or the like.

The processing section 202 is a processor such as a central processing unit (CPU), a micro processing unit (MPU), or an application specific integrated circuit (ASIC), for example. The processing section 202 includes one or more processors. The processing section 202 has a function as a calculation device that performs control processing, calculation processing, and the like. The processing section 202 controls the storage section 204, the communication section 206, the user IF 208, and the printing section 210.

The storage section 204 is a storage device including one or more memories or storages, or a combination thereof. Since examples of the memories and the storages are similar to the examples of the storage section 104, description thereof will be omitted. The storage section 204 has a function of storing a control program, a calculation program, and the like to be executed by the processing section 202. In addition, the storage section 204 has a function of temporarily storing processing data and the like. Furthermore, the storage section 204 has a function of storing the main body information of the printer 200. The main body information stored in the storage section 204 may be updated as appropriate.

The communication section 206 performs processing necessary for the printer 200 to communicate with another device via a communication network. The communication section 206 can include a communication port, a router, a firewall, and the like. For example, the communication section 206 performs processing for the printer 200 to communicate with the external computer 100. The communication section 206 may perform processing for the printer 200 to communicate with the external computer 100 via a LAN such as a wireless LAN. In addition, the communication section 206 may perform processing for the printer 200 to communicate with the external computer 100 via the Internet.

The user IF 208 has an input device such as a button, a keyboard, or a mouse, and an output device such as a display or a speaker. The user IF 208 may be one in which an input device and an output device are integrally configured, such as a touch panel. The user IF 208 receives an operation of inputting data to the printer 200 by the user, and outputs information from the printer 200 to the user.

The printing section 210 has a printing function for forming an image on paper, that is, a print medium. The printing section 210 includes a print engine. The print engine is a mechanical configuration that executes printing of an image onto the print medium. The print engine may have a mechanism for performing printing with a toner, for example, by an electrophotographic method. Alternatively, the print engine may have a mechanism for performing printing by, for example, an ink jet method. In addition, the print engine may have a transport mechanism that transports the print medium.

The sheet tray 222 is a tray for supplying sheets for printing. Note that the main body information of the printer 200 may include information indicating characteristics of the printing section 210 and the sheet tray 222.

The printer 200 further includes the print job receiving section 224. The print job receiving section 224 can be implemented by executing a program, for example, under control of the processing section 202. More specifically, the print job receiving section 224 can be implemented by the processing section 202 executing a program stored in the storage section 204. In addition, a necessary program may be recorded on any non-volatile recording medium and installed in the printer 200 as necessary, and accordingly, the print job receiving section 224 may be implemented.

The print job receiving section 224 receives a print job from the external computer 100. The print job receiving section 224 may be implemented by the communication section 206. The received print job is output to the printing section 210. The printing section 210 executes printing in accordance with the print job. In other words, the printing section 210 executes printing in accordance with an instruction from the external computer 100.

### Description of Processing Flow

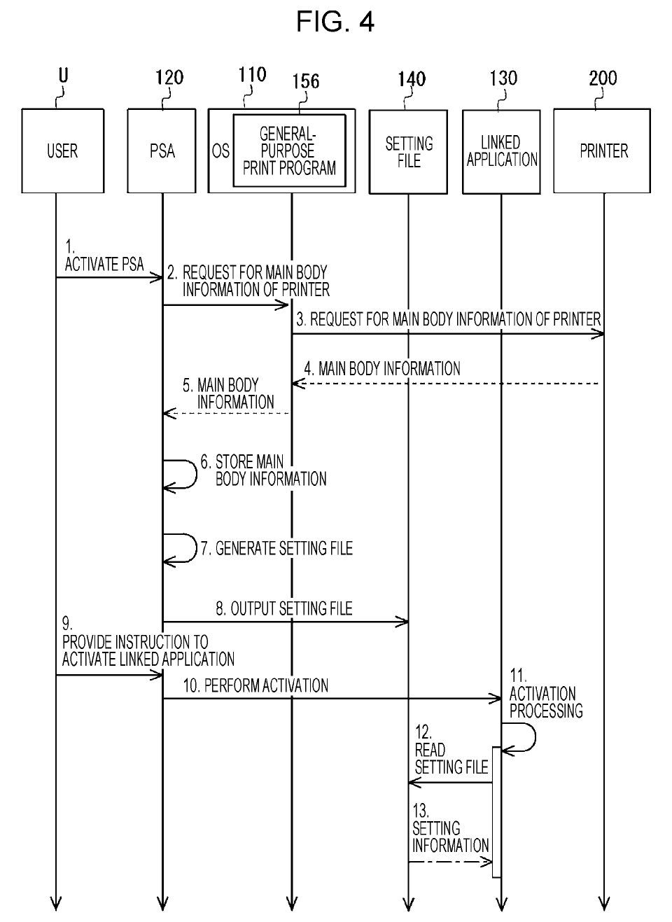

FIG. 4 is a sequence diagram illustrating a flow of setting in the print system 1 according to the first embodiment. FIG. 4 illustrates description regarding a user U, the PSA 120, the OS 110, the setting file 140, and the linked application 130, which are components of the external computer 100, and the printer 200. Note that as a function of the OS 110, the general-purpose print program 156 will be particularly described. In addition, each function executed by the PSA 120 will be described using the acquisition section 162, the generation section 164, the output section 166, and the activation section 168 described above.

Hereinafter, a flow of processing of the external computer 100 and the printer 200 and details thereof will be described with reference to FIG. 4.

(1) First, the user U operates the input section 152 to output an instruction to create the setting file 140 to the external computer 100. (2) In response to receiving the creation instruction, the acquisition section 162 outputs a request for the main body information of the printer 200 to the OS 110. (3) In response to receiving the request for the main body information, the general-purpose print program 156 outputs the request for the main body information to the printer 200.

(4) In response to receiving the request for the main body information, the printer 200 transmits the main body information stored in the storage section 204 to the OS 110. (5) In response to receiving the main body information, the general-purpose print program 156 outputs the main body information to the PSA 120.

(6) The acquisition section 162 acquires the main body information. The acquisition section 162 causes the storage section 104 to store the acquired main body information. (7) The generation section 164 converts the format of the main body information to match the setting format of the linked application 130. The generation section 164 creates the setting file 140 including data to be used for setting of the linked application 130 by using the converted main body information. Here, the generation section 164 provides, in the setting file 140, a specification area for specifying initial setting at the time of the next activation of the linked application 130. The generation section 164 sets information corresponding to the acquired main body information in the specification area. (8) The output section 166 outputs the generated setting file 140 to an area of the linked application 130 that is a target of print setting. Also, a path of the setting file 140 is stored in the storage section 204.

(9) The user U operates the input section 152 to output an instruction to activate the linked application 130 to the external computer 100. At this time, the user U includes the path of the setting file 140 in the instruction. (10) In response to receiving the activation instruction, the activation section 168 outputs an activation request to the linked application 130. The activation request includes the path of the setting file 140.

(11) The linked application 130 executes activation processing in response to receiving the activation request. Here, the linked application 130 determines, by referring to the path included in the activation request, whether or not a setting file for the linked application 130 has already been created. In this case, the setting file 140 has already been created. (12) Therefore, the linked application 130 executes processing of reading the created setting file 140. (13) The linked application 130 acquires the setting information in the setting file 140 by reading the setting file 140. As described above, the linked application 130 completes the setting processing in accordance with the main body information of the printer 200.

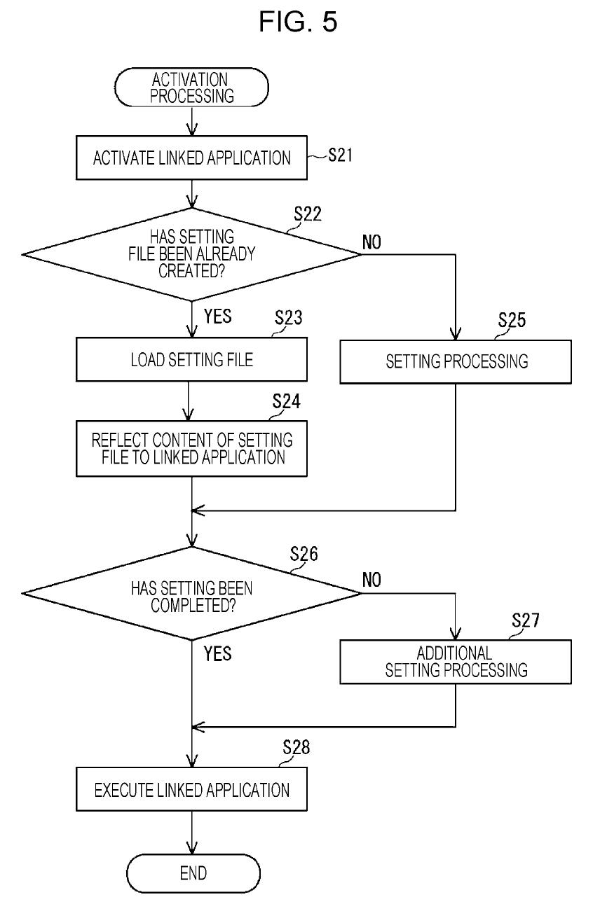

FIG. 5 is a flowchart illustrating a procedure of the activation processing of the linked application 130. Processing (11) to processing (13) in FIG. 4 will be described in detail below with reference to FIG. 5.

(S21) First, the linked application 130 executes the activation processing in response to receiving an activation request. The processing in (S21) corresponds to (11) in FIG. 4. (S22) Next, the linked application 130 determines, by referring to the path included in the activation request, whether or not a setting file for the linked application 130 has already been created. Specifically, the linked application 130 refers to the area for setting the linked application 130 indicated by the path, and determines whether or not the setting file for the linked application 130 is present in the area.

(S23) In a case in which the setting file 140 for the linked application 130 is present in the area for setting, the linked application 130 executes processing of reading the setting file 140 that is present in the area for setting. (S24) The linked application 130 executes processing of reflecting setting information, which is content of the setting file 140, to the linked application 130. The processing in (S23) and the processing in (S24) correspond to (12) and (13) in FIG. 4.

(S25) On the other hand, in a case in which the setting file for the linked application 130 is not present in the area for setting, the linked application 130 executes setting processing in accordance with the main body information of the printer 200. In other words, the linked application 130 itself acquires the main body information, and generates, based on the main body information, the setting information necessary for the setting of the linked application 130. In the processing in (S25), the linked application 130 needs to newly create the setting information. Therefore, it is assumed that the processing in (S25) takes a longer time than the processing in (S23) and (S24).

(S26) After the processing in (S24) or (S25) described above is ended, the linked application 130 determines whether or not the setting of itself has been completed. (S27) In a case in which it is determined that all information necessary for the setting of the linked application 130 has not yet been acquired, the linked application 130 acquires and sets information which is necessary for the setting but has not been acquired. (S28) On the other hand, in a case in which it is determined that all information necessary for the setting of the linked application 130 has been acquired, the linked application 130 is executed using the acquired setting information.

Note that in a case in which a plurality of linked applications 130 are present in the external computer 100, the setting processing of the linked application 130 described above may be executed for each linked application 130.

### Description of Effects

In the first embodiment, the external computer 100 executes the following processing by executing a program related to the PSA 120. The acquisition section 162 acquires the main body information of the printer 200 from the printer 200. The generation section 164 generates setting files including data to be used for setting one or more linked applications 130 based on the acquired main body information. By the processing described above, the external computer 100 can generate in advance the setting files 140 to be used for setting the linked applications 130. Therefore, when the linked applications 130 are activated, the linked applications 130 do not need to newly generate necessary setting information, and can execute the setting by reading the setting files 140 generated in advance. Since the time required for setting the linked applications 130 is shortened, the user can use the linked applications 130 more quickly.

Furthermore, in a case in which the linked applications 130 newly generate setting information, a user operation for the generation may be required. On the other hand, the setting files 140 are generated in advance in the first embodiment. Therefore, the user can set the linked applications 130 only by designating information for specifying the setting files 140. Therefore, convenience of the user is also improved.

As described above, the user can more efficiently use the linked applications 130 by the processing of the external computer 100.

Note that a case is also assumed in which although the setting files 140 have been generated in advance, all the information necessary for the setting of the linked applications 130 has not been set in the setting files 140. In such a case, the processing in S27 is executed after the processing in S23 and S24 is performed in FIG. 5. However, even in this case, it is assumed that the time required for the setting of the linked applications 130 is shortened as compared with a case in which the processing in S25 is executed with the setting file 140 not generated in advance. This is because the information necessary for the setting of the linked applications 130, even in part, has been generated by the setting files 140, and the linked applications 130 do not need to generate the corresponding setting information.

In addition, the external computer 100 can execute the above-described processing by using the PSA 120. Therefore, the external computer 100 can achieve the above-described effects even in an environment in which the print processing is performed using a general-purpose driver which is generally used.

Furthermore, the output section 166 of the external computer 100 can output the generated setting files 140 to the area for setting the one or more linked applications 130. After the output section 166 outputs the setting files 140, the activation section 168 activates the one or more linked applications 130 in response to an instruction from the user. In a case in which the user activates the linked applications 130, it is only necessary for the linked applications 130 to refer to the area for setting in order to read the setting files 140. Therefore, the time for the linked applications 130 to read the setting files 140 is shortened, and the user can thus use the linked applications 130 more quickly.

Furthermore, in the processing of generating the setting files 140, the generation section 164 can provide, in the setting files 140, the specification areas for specifying initial setting for the next activation of the one or more linked applications 130. The generation section 164 sets information corresponding to the main body information in the specification areas. By the linked applications 130 reading the specification areas when activated, information corresponding to the main body information is set. Therefore, the linked applications 130 can read setting corresponding to the main body information of the printer 200 as initial setting at the time of activation. As a result, the linked applications 130 can quickly execute printing in accordance with the main body information of the printer 200.

Note that even in a case in which the generation section 164 generates a plurality of setting files 140, the formats of the setting files 140 can be unified. Therefore, the total capacity of the setting files 140 to be stored in the storage section 104 can also be reduced.

### Second Embodiment

In a second embodiment described below, description of the points that have already been described above in the first embodiment will be appropriately omitted, and differences from the first embodiment will be mainly described.

### Description of Configuration

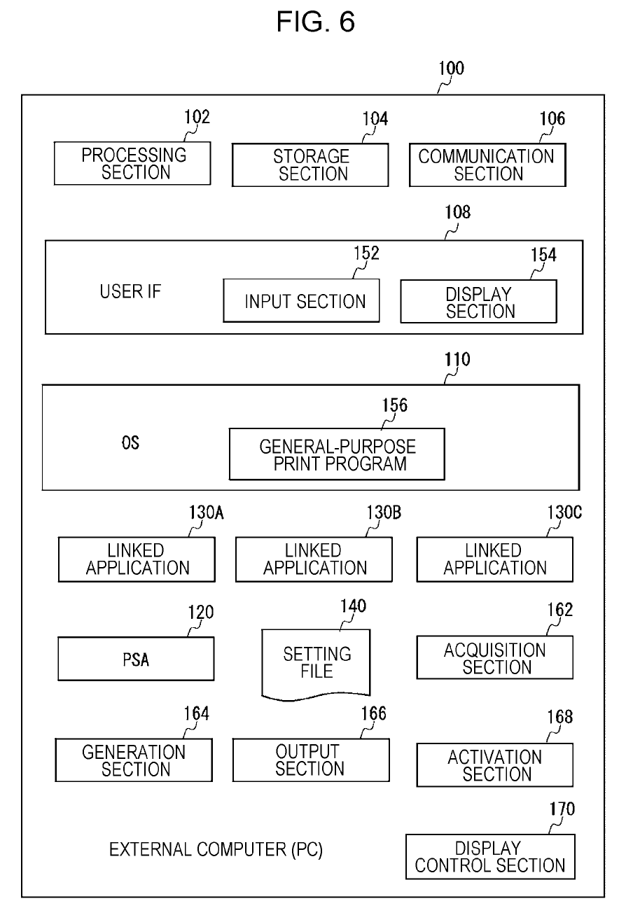

FIG. 6 is a block diagram illustrating an example of an external computer 100 according to the second embodiment. The external computer 100 is different from the external computer 100 according to FIG. 2 in that the external computer 100 according to the second embodiment includes a plurality of linked applications 130A to 130C and further includes a display control section 170. Note that the number of linked applications 130 included in the external computer 100 is not limited to three, and the external computer 100 may include two or four or more linked applications 130.

The display control section 170 may be implemented by the PSA 120 as a function for print setting, similarly to the acquisition section 162 to the activation section 168. For example, the display control section 170 can be implemented by the processing section 102 reading and executing a program related to the PSA 120 stored in the storage section 104. In addition, a necessary program may be recorded on any non-volatile recording medium and installed in the external computer 100 as necessary, and accordingly, each of the components may be implemented.

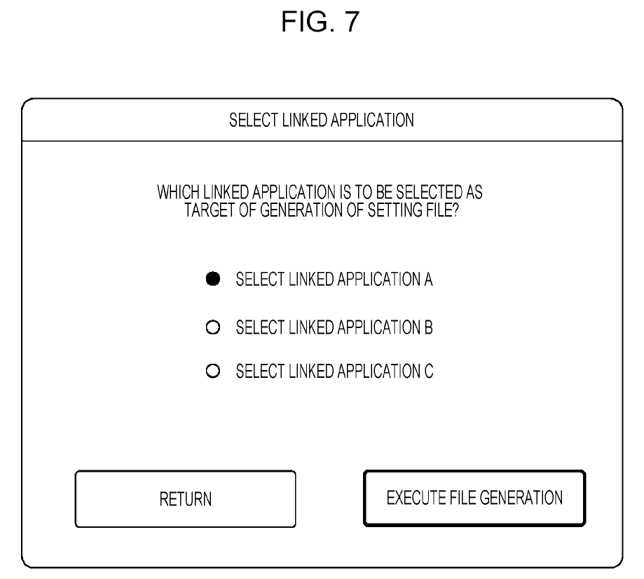

In (2) of FIG. 4, the display control section 170 causes the display section 154 to display a display screen in response to receiving an instruction to create the setting file 140. FIG. 7 is a diagram illustrating a display screen for selecting a linked application. The display control section 170 allows, by causing the display screen to be displayed, a user to select one linked application 130 from among the plurality of linked applications 130A to 130C as a target of generation of a setting file. The linked applications A to C in FIG. 7 correspond to the linked applications 130A to 130C in FIG. 6. The user operates the input section 152 to select a radio button illustrated in FIG. 7. Accordingly, the user selects any linked application 130 from among the linked applications 130A to 130C as a target of generation of the setting file 140.

Furthermore, the display control section 170 causes the display section 154 to display "execute file generation" illustrated in FIG. 7 as a button for generating the setting file 140. After selecting any linked application 130, the user presses the "execute file generation" button via the input section 152. As a result, the user provides an instruction to generate the setting file 140 for the selected linked application 130.

The generation section 164 generates the setting file 140 including data to be used for setting the selected linked application 130 based on the input instruction and main body information acquired in the processing illustrated in (2) to (5) of FIG. 4. Details of the generation are as illustrated in (6) to (8) of FIG. 4. Accordingly, the external computer 100 can generate the setting file 140 related to the selected linked application 130.

However, the display control section 170 may cause the display section 154 to display a display screen on which the user can select two linked applications 130 from among the linked applications 130A to 130C. Even in this case, the user can select any two linked applications 130 from among the linked applications 130A to 130C. In addition, the display control section 170 may cause the display section 154 to display a display screen on which the user can select all of the linked applications 130 from among the linked applications 130A to 130C. Even in this case, the user can select all of the linked applications 130A to 130C. The user provides an instruction to generate setting files 140 for the selected linked applications 130. Thus, the user can generate the setting file 140 for each of the selected linked applications 130.

Furthermore, the generation section 164 may generate, for the unselected linked application 130, a setting file 140 corresponding to the setting files 140 for the selected linked applications 130. For example, it is assumed that a plurality of printers 200A and 200B as printers 200 are connected to the external computer 100. Furthermore, the user presses the "execute file generation" button via the input section 152 after selecting the linked application 130A on the display screen illustrated in FIG. 7.

At this time, the generation section 164 executes, based on the main body information, processing of generating a setting file 140A including data to be used for setting the linked application 130A such that the printer 200A from among the plurality of printers is registered as an activation device of the linked application 130A. This processing will also be referred to as processing A below. In this case, the generation section 164 further executes processing of generating a setting file 140B including data to be used for setting the linked application 130B such that the printer 200A is registered as an activation device of the linked application 130B. This processing will also be referred to as processing B below. In addition, the generation section 164 may further execute processing of generating a setting file 140C including data to be used for setting the linked application 130C such that the printer 200A is registered as an activation device of the linked application 130C. This processing will also be referred to as processing C below. Here, the generation section 164 may execute the processing B or C at the same time as the processing A or may execute the processing B or C at a different timing.

However, the generation section 164 may execute the processing A even in a case in which the display screen illustrated in FIG. 7 is not displayed and there is no instruction for the processing A by the user. In this case, the generation section 164 can execute the processing B or C at the same time as the processing A.

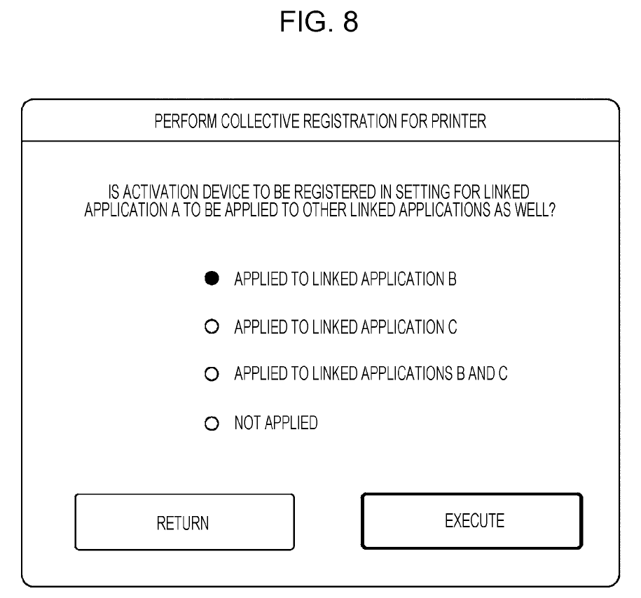

The display control section 170 can cause the display section 154 to display, at a timing before (2) in FIG. 4, a display screen for allowing the user to select whether or not to execute the processing B or C together with the processing A. FIG. 8 is a diagram illustrating a display screen for collective registration of a printer. By displaying the display screen, the display control section 170 allows the user to select whether or not the activation device to be registered in the setting file 140A of the linked application 130A is also applied to other linked applications 130. The user operates the input section 152 to select the radio button illustrated in FIG. 7. Accordingly, the user can designate the activation device to be registered in the setting file 140A of the linked application 130A also being applied to the setting file 140B of the linked application 130B or the setting file 140C of the linked application 130C.

The display control section 170 causes the display section 154 to display "execute" illustrated in FIG. 8 as a button for fixing the designated content. For example, after selecting the linked application 130B on the display screen of FIG. 8, the user presses the "execute" button via the input section 152. In this way, the user provides, before the processing A is executed, an instruction to execute the processing B together with the processing A. In response to the instruction, the generation section 164 executes the processing B at the same time as the processing A when executing the processing A. Note that the external computer 100 can execute similar setting for the linked application 130C instead of the linked application 130B.

The user may also designate the activation device to be registered in the setting file 140A also being applied to both the setting files 140B and 140C. Furthermore, the user may designate the activation device to be registered in the setting file 140A not being applied to the setting files 140 of other linked applications 130. After the user executes the designation, the user provides an instruction for the designated content by pressing the "execute" button via the input section 152. In response to the instruction, the generation section 164 executes the processing B and C at the same time as the processing A when executing the processing A. Alternatively, the generation section 164 does not execute each of the processing B and the processing C together with the processing A in response to the instruction.

### Description of Effects

In the second embodiment, the external computer 100 executes the following processing by executing the program related to the PSA 120. The display control section 170 executes first display processing of causing the display section 154 to display the selection screen for allowing the user to select one or more linked applications 130 from among the plurality of linked applications 130. The generation section 164 executes first generation processing of generating the setting files 140 including data to be used for setting the selected one or more linked applications 130 based on the acquired main body information. Through the processing described above, the external computer 100 can allow the user to select the linked application 130 as a target of generation of the setting files 140. Therefore, the user can flexibly execute the setting of the linked application 130.

In the first generation processing, the setting file 140A including data to be used for setting the linked application 130A may be generated such that a predetermined printer is registered as an activation device of the linked application 130A. At this time, the generation section 164 can execute second generation processing of generating the setting file 140B including data to be used for setting the linked application 130B such that a predetermined printer is registered as an activation device of the linked application 130B. Therefore, the external computer 100 can collectively register the same predetermined printer as the activation device for the linked application 130A and the linked application 130B. Since the time required for setting the plurality of linked applications 130 is shortened, the user can use the linked applications 130 more quickly.

In addition, the display control section 170 can execute second display processing of causing the display section 154 to display the selection screen for allowing the user to select whether or not to execute the second generation processing together with the first generation processing. Therefore, the user can flexibly execute the setting of the linked applications 130.

Note that the present disclosure is not limited to the above embodiments and can be appropriately changed in a range without departing from the gist thereof. For example, one or more of the processes of the sequence in FIG. 4 described above may be omitted. Furthermore, the PSA 120 may acquire the main body information directly from the printer 200 without using the OS 110.

In the first embodiment, the case in which the OS 110 of the external computer 100 is Windows has been described. However, the OS 110 is not limited to Windows and may be any operating system such as macOS (registered trademark) or Linux (registered trademark), for example.

In the above-described examples, the program includes a group of commands (or software codes) for causing a computer to perform one or more functions described in the embodiments when read by the computer. The program may be stored in a non-transitory computer-readable medium or a physical storage medium. By way of non-limiting example, the computer-readable medium or the physical storage medium includes a random-access memory (RAM), a read-only memory (ROM), a flash memory, a solid-state drive (SSD), or other memory technologies. In other examples, the computer-readable medium or the physical storage medium includes a CD-ROM, a digital versatile disk (DVD), a Blu-ray (registered trademark) disk, or other optical disk storages, a magnetic cassette, a magnetic tape, a magnetic disk storage, or other magnetic storage devices. The program may be transmitted on a transitory computer-readable medium or a communication medium. By way of non-limiting example, the transitory computer-readable medium or the communication medium includes a propagating signal in an electrical, optical, acoustic, or other forms. In addition, the program is included in a program product.

What is claimed is:

1. A non-transitory computer-readable storage medium storing a program for extending a general-purpose driver, the program causing a computer to execute:
acquiring processing of acquiring, from a printing apparatus, main body information of the printing apparatus; and
first generation processing of generating, based on the main body information, a setting file including data to be used for setting one or more linked applications.

2. The non-transitory computer-readable storage medium according to claim 1, wherein the program is a print support application.

3. The non-transitory computer-readable storage medium according to claim 1,
wherein the program further causes the computer to execute:
outputting processing of outputting the setting file generated by the first generation processing to an area for setting the one or more linked applications; and
activating processing of activating the one or more linked applications in response to an instruction from a user after the outputting processing.

4. The non-transitory computer-readable storage medium according to claim 1, wherein the program causes, in the first generation processing, the computer to provide an area for specifying initial setting at a time of next activation of the one or more linked applications in the setting file and set information corresponding to the main body information in the area.

5. The non-transitory computer-readable storage medium according to claim 1,
wherein the program further causes the computer to execute
first display processing of displaying a screen for allowing a user to select the one or more linked applications from among a plurality of linked applications, and
in the first generation processing, to generate, based on the main body information, the setting file including data to be used for setting the selected one or more linked applications.

6. The non-transitory computer-readable storage medium according to claim 5, wherein the program further causes the computer to execute
second generation processing, when a first setting file including data to be used for setting a first linked application is generated in the first generation processing such that a predetermined printing apparatus is registered as an activation device of the first linked application, of generating a second setting file including data to be used for setting a second linked application such that the predetermined printing apparatus is registered as an activation device of the second linked application.

7. The non-transitory computer-readable storage medium according to claim 6, wherein the program further causes the computer to execute
second display processing of displaying a screen for allowing the user to select whether or not to execute the second generation processing together with the first generation processing.

8. An information processing apparatus comprising:
an acquisition section that acquires, from a printing apparatus, main body information of the printing apparatus; and
a generation section that generates, based on the main body information, a setting file including data to be used for setting one or more linked applications.

9. A setting method comprising, by a computer:
acquiring, from a printing apparatus, main body information of the printing apparatus; and
generating, based on the main body information, a setting file including data to be used for setting one or more linked applications.
